(19) United States
(12) Patent Application Publication
(10) Pub. No.: US 2021/0158255 A1
(43) Pub. Date: May 27, 2021

(54) INFORMATION PROCESSING APPARATUS, NON-TRANSITORY STORAGE MEDIUM, AND INFORMATION PROCESSING METHOD

(71) Applicant: TOYOTA JIDOSHA KABUSHIKI KAISHA, Toyota-shi (JP)

(72) Inventor: Daiki KANEICHI, Shinagawa-ku (JP)

(73) Assignee: TOYOTA JIDOSHA KABUSHIKI KAISHA, Toyota-shi (JP)

(21) Appl. No.: 17/092,446

(22) Filed: Nov. 9, 2020

(30) Foreign Application Priority Data
Nov. 25, 2019 (JP) 2019-212304

(51) Int. Cl. G06Q 10/06; G06Q 30/06; G06Q 50/30; G06Q 30/02; G06Q 10/02

(52) U.S. Cl. CPC G06Q 10/06315; G06Q 30/0645; G07C 5/04; G06Q 30/0201; G06Q 10/02; G06Q 50/30

(57) ABSTRACT

An information processing apparatus of the present disclosure includes: a first storage configured to store a load tendency of each user in association with each user; a second storage configured to store a load history of each rental vehicle in association with each rental vehicle; and a controller configured to select, upon generation of a rental request from a desired user, a vehicle to be rented to the desired user from among a plurality of rental vehicles that are available for rent, based on a load tendency stored in the first storage in association with the desired user, and a load history stored in the second storage in association with each of the plurality of rental vehicles available for rent.

### CROSS-REFERENCE TO RELATED APPLICATIONS

This application claims the benefit of Japanese Patent Application No. 2019-212304, filed on Nov. 25, 2019, which is hereby incorporated by reference herein in its entirety.

### BACKGROUND

### Technical Field

The present disclosure relates to an information processing apparatus, a non-transitory storage medium, and an information processing method.

### Description of the Related Art

There has been known a technology for determining whether a rental vehicle can be reused, according to the travel distance of the vehicle (see, for example, Patent Literature 1).

### CITATION LIST

### Patent Literature

Patent Literature 1: Japanese Patent Application Laid-Open Publication No. 2005-222147

### SUMMARY

The present disclosure is intended to provide a technology that, upon renting a rental vehicle to a user, allows a vehicle suitable for each individual user to be rented out.

A first aspect of the present disclosure can be taken as an information processing apparatus that manages rental vehicles, which are vehicles to be rented to users.

Specifically, the information processing apparatus may include:

a first storage configured to store a load tendency in the form of information indicating a tendency of a load applied to a rental vehicle by each user when each user uses the rental vehicle, in association with each user;

a second storage configured to store a load history in the form of information indicating a history of a load received by each rental vehicle when each rental vehicle is rented out, in association with each rental vehicle; and

a controller configured to extract, upon generation of a rental request from a desired user who is a user to desire to rent a rental vehicle, a load tendency stored in the first storage in association with the desired user and a load history stored in the second storage in association with each of a plurality of rental vehicles that are available for rent, and to select a vehicle to be rented to the desired user from among the plurality of rental vehicles available for rent based on the load tendency and the load history thus extracted.

A second aspect of the present disclosure can be taken as an information processing program for managing rental vehicles that are vehicles to be rented to users, or a non-transitory storage medium storing the information processing program.

The information processing program in such a case may be configured to cause a computer to perform an extraction step and a selection step when a rental request is generated from a desired user who desires to rent a rental vehicle, wherein

the computer comprises: a first storage configured to store a load tendency in the form of information indicating a tendency of a load applied to a rental vehicle by each user when each user has utilized the rental vehicle, in association with each user; and a second storage configured to store a load history in the form of information indicating a history of a load received by each rental vehicle when each rental vehicle has been rented out, in association with each rental vehicle;

the extraction step is configured to extract a load tendency stored in the first storage in association with the desired user and a load history stored in the second storage in association with each of a plurality of rental vehicles that are available for rent; and

the selection step is configured to select a vehicle to be rented to the desired user from among the plurality of rental vehicles available for rent based on the load tendency and the load history extracted in the extraction step.

A third aspect of the present disclosure can be taken as an information processing method for managing rental vehicles that are vehicles to be rented to users.

Specifically, the information processing method may be configured such that a computer, which includes a first storage configured to store a load tendency in the form of information indicating a tendency of a load applied to a rental vehicle by each user when each user has utilized the rental vehicle, in association with each user, and a second storage configured to store a load history in the form of information indicating a history of a load received by each rental vehicle when each rental vehicle has been rented out, in association with each rental vehicle, performs, upon generation of a rental request from a desired user who desires to rent a rental vehicle,

an extraction step of extracting a load tendency stored in the first storage in association with the desired user and a load history stored in the second storage in association with each of a plurality of rental vehicles that are available for rent; and

a selection step of selecting a vehicle to be rented to the desired user from the plurality of rental vehicles available for rent based on the load tendency and the load history extracted in the extraction step.

According to the present disclosure, it is possible to provide a technology in which when a rental vehicle is rented to a user, a vehicle suitable for each individual user can be rented out.

### BRIEF DESCRIPTION OF THE DRAWINGS

FIG. 1 is a view showing an outline of a vehicle rental system.

FIG. 2 is a view illustrating an example of the hardware configuration of a server apparatus according to a first embodiment of the present disclosure.

FIG. 3 is a block diagram illustrating an example of the functional configuration of the server apparatus in the first embodiment.

FIG. 4 is a view illustrating a configuration example of a load tendency information table in the first embodiment.

FIG. 5 is a view illustrating a configuration example of a load history information table in the first embodiment.

FIG. 6 is a flowchart illustrating the flow of the processing performed by the server apparatus in the first embodiment.

FIG. 7 is a flowchart illustrating the flow of the processing of selecting a renting vehicle in the first embodiment.

FIG. 8 is a view illustrating a configuration example of a load tendency information table in a second embodiment of the present disclosure.

FIG. 9 is a view illustrating a configuration example of a load history information table in the second embodiment.

FIG. 10 is a flowchart illustrating the flow of the processing of selecting a renting vehicle in the second embodiment.

FIG. 11 is a view illustrating a configuration example of a load tendency information table in a third embodiment of the present disclosure.

FIG. 12 is a view illustrating a configuration example of a load history information table in the third embodiment.

FIG. 13 is a flowchart illustrating the flow of the processing of selecting a renting vehicle in the third embodiment.

FIG. 14 is a view illustrating a configuration example of a load tendency information table in a fourth embodiment of the present disclosure.

FIG. 15 is a view illustrating a configuration example of a load history information table in the fourth embodiment.

FIG. 16 is a flowchart illustrating the flow of the processing of selecting a renting vehicle in the fourth embodiment.

FIG. 17 is a view illustrating a configuration example of a load tendency information table in a fifth embodiment of the present disclosure.

FIG. 18 is a view illustrating a configuration example of a load history information table in the fifth embodiment.

FIG. 19 is a flowchart illustrating the flow of the processing of selecting a renting vehicle in the fifth embodiment.

### DESCRIPTION OF THE EMBODIMENTS

An information processing apparatus of the present disclosure is applied to a vehicle rental service, which is a service for renting rental vehicles to users.

Here, the tendency of a load that each user applies to a rental vehicle when the user uses the rental vehicle differs for each user. In addition, the history of a load that each rental vehicle receives from each user when the rental vehicle is rented to the user differs for each rental vehicle. Here, the “load” referred to herein includes, for example, a load related to driving or travel performance such as a travel distance, a battery consumption amount, a load weight, etc., or a load related to indoor comfort such as a residual smell (e.g., the smell of a cigarette, the smell of a pet, etc.), which is a smell remaining in the interior of each rental vehicle.

However, if the load related to the travel performance among the above-mentioned loads is concentrated on a specific rental vehicle, the service life of the specific rental vehicle may become significantly shorter than those of the other rental vehicles. Therefore, it is preferable to distribute the load related to the travel performance to a plurality of rental vehicles. On the other hand, it is preferable to concentrate the load related to the indoor comfort on specific rental vehicles. This is because if a rental vehicle with the smell of cigarettes remaining therein is rented to a user who does not smoke, or if a rental vehicle with the smell of pets remaining therein is rented to a user who does not keep pets, the comfort of those users will be compromised.

Accordingly, the information processing apparatus of the present disclosure accumulates the load tendency of each user and the load history of each rental vehicle, and selects (determines) a vehicle to be rented to each user based on the load tendency and the load history of the user. Specifically, in the information processing apparatus of the present disclosure, information indicating the tendency of a load applied to the rental vehicle by each user when each user uses the rental vehicle (load tendency) is stored in a first storage in association with each user. Also, in the information processing apparatus of the present disclosure, information indicating a history of a load received by each rental vehicle when each rental vehicle is rented out (load history) is stored in a second storage in association with each rental vehicle. In addition, in the information processing apparatus of the present disclosure, when a rental request is generated from a desired user who is a user desiring to rent a rental vehicle, the controller extracts a load tendency stored in the first storage in association with the desired user. Moreover, the controller extracts a load history stored in the second storage in association with each of a plurality of rental vehicles that are available for rent to the desired user. The controller selects a vehicle to be rented to the desired user based on the load tendency and the load history thus extracted. Accordingly, the controller can select a rental vehicle with the load history matching the load tendency of the desired user, as a vehicle to be rented to the desired user (hereinafter, also referred to as a “renting vehicle”). As a result, it also becomes possible to suppress the load related to the travel performance from concentrating on a specific rental vehicle as well as the load related to the indoor comfort from being distributed to a plurality of rental vehicles.

Here, in cases where the travel distance is used as the load of the rental vehicle, the travel distance used as the load tendency of the user may be, for example, a total travel distance or a continuous travel distance. The total travel distance is a cumulative total of distance that the rental vehicle has been made to travel by the user when the user has used the rental vehicle (i.e., a cumulative total of distance traveled by the rental vehicle during a rental period per one time). The continuous travel distance is a distance that the rental vehicle has been made to travel continuously by the user when the user has used the rental vehicle. Here, note that for a user who has used the rental vehicle a plurality of times, an average value of the total travel distances or the continuous travel distances in a plurality of uses may be stored in the first storage as the load tendency of that user. In an alternative way, a maximum value of the total travel distances or a maximum value of the continuous travel distances in a plurality of uses may be stored in the first storage as the load tendency of that user.

In a mode using the total travel distance as the load tendency stored in the first storage, the controller may select, as the renting vehicle, a rental vehicle having a smaller cumulative travel distance when the total travel distance of the desired user is large than when the total travel distance is small. The “cumulative travel distance” referred to herein is the cumulative travel distance of each rental vehicle from the time the vehicle was new. Accordingly, the cumulative travel distance of a specific rental vehicle is suppressed from becoming significantly longer than those of other rental vehicles. As a result, the service life of the specific rental vehicle is suppressed from becoming significantly shorter than those of other rental vehicles.

In another mode using the continuous travel distance as the load tendency stored in the first storage, the controller may select, as the renting vehicle, a rental vehicle having a load history in which the continuous travel distance is smaller when the continuous travel distance of the desired user is large than when the continuous travel distance is small. This serves to suppress a specific rental vehicle from becoming significantly larger than other rental vehicles in terms of the number of times the vehicle is continuously driven over a relatively long distance or the number of times the vehicle is continuously driven over an extremely short distance. As a result, the service life of the specific rental vehicle is suppressed from becoming significantly shorter than those of other rental vehicles. Here, it should be noted that the number of times the rental vehicle is continuously driven during the rental period per one time is not limited to one. Therefore, in cases where the number of times of continuous travel of the rental vehicle 10 by the user during the rental period per one time is more than one, an average value of the continuous travel distances in the plurality of times may be used as the load tendency. Alternatively, a maximum value of the continuous travel distances in a plurality of times may be used as the load tendency.

Next, in a further mode using the battery consumption amount as the load tendency stored in the first storage, the controller may select, as the renting vehicle, a rental vehicle in which a full charge amount of a battery is larger when the battery consumption amount of the desired user is large than when the battery consumption amount of the desired user is small. The “battery” referred to herein is a battery for driving the rental vehicle. That is, in cases where the rental vehicle is a vehicle that is driven by making use of battery power (e.g., an EV (electric vehicle), a PHV (plug-in hybrid vehicle), or the like), the battery consumption amount can be used as the load tendency of the user. Also, the “battery consumption amount” referred to herein is a cumulative total of amount of battery consumption of the rental vehicle during the rental period per one time. Here, note that for a user who has used a rental vehicle a plurality of times, an average value of the battery consumption amounts in a plurality of uses may be stored in the first storage as the load tendency of that user. In an alternative way, a maximum value of the total travel distances or a maximum value of the battery consumption amounts in a plurality of uses may be stored in the first storage as the load tendency of that user. In addition, the “full charge amount of the battery” as used herein refers to a discharge capacity of the battery when the battery is in a fully charged state (i.e., a state in which the battery cannot be charged any more).

Here, the battery tends to degrade as the number of battery charges increases. Accordingly, the full charge amount of the battery tends to decrease as the number of battery charges increases. Therefore, if vehicles to be rented to users who consume a large amount of battery power are biased toward a specific rental vehicle, the number of battery charges of the specific rental vehicle will increase, as a result of which there will be a possibility that the battery degradation of the specific rental vehicle progresses significantly in comparison to other rental vehicles.

In contrast to this, in the case where the battery consumption amount of a desired user is large, if a rental vehicle with a large battery full charge amount is rented to the desired user, the number of battery charges of a specific rental vehicle will be suppressed from becoming significantly larger than those of other rental vehicles, as compared with the case where the battery consumption amount of the desired user is small. As a result, the degree of degradation of the battery of the specific rental vehicle will be suppressed from becoming significantly larger than those of other rental vehicles.

Then, in a still further mode using the load weight as the load tendency stored in the first storage, the controller may select, as the renting vehicle, a rental vehicle having a load history in which the load weight is smaller when the load weight of a desired user is large than when the load weight is small. Here, a rental vehicle having a load history with a large load weight may have a vehicle body, a suspension, or the like deteriorated more than a rental vehicle having a load history with a small load weight. Therefore, if vehicles to be rented to users having a load tendency with a large load weight are biased toward a specific rental vehicle, the specific rental vehicle (e.g., the body, suspension, or the like) may have a significantly shorter service life than those of other rental vehicles. In contrast to this, when the load weight of a desired user is large, if a rental vehicle having a load history with a small load weight is rented to the desired user, the service life of a specific rental vehicle is suppressed from becoming significantly shorter than those of other rental vehicles.

Further, in a yet further mode using the presence or absence of a residual smell as the load tendency stored in the first storage, in cases where the load tendency of a desired user has the presence of a residual smell, the controller may select, as the renting vehicle, a rental vehicle having a load history of the presence of a residual smell. Thus, vehicles to be rented to users having a load tendency with the presence of a residual smell can be concentrated on rental vehicles having a load history with a residual smell. As a result, a rental vehicle having a load history with the presence of a residual smell is suppressed from being rented to a user having a load tendency with the absence of a residual smell. Therefore, it is possible to ensure comfort when a user having a load tendency with the absence of a residual smell makes use of a rental vehicle.

Hereinafter, specific embodiments of the present disclosure will be described based on the accompanying drawings. The dimensions, materials, shapes, relative arrangements and so on of component parts described in the embodiments are not intended to limit the technical scope of the present disclosure thereto unless otherwise stated.

### First Embodiment

In this embodiment, an example will be described in which an information processing apparatus of the present disclosure is applied to a service (i.e., vehicle rental service) in which a plurality of rental vehicles that can be rented to users are placed under management, wherein a rental vehicle will be rented out in response to a rental request from a user.

(System Overview)

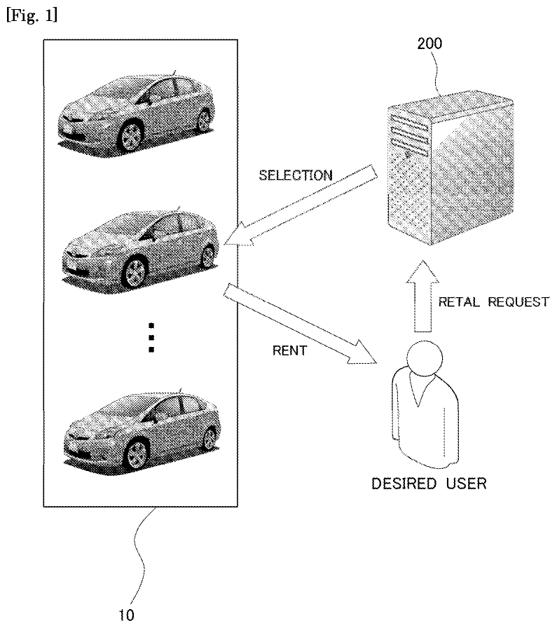

FIG. 1 is a view illustrating an outline of a system that provides the vehicle rental service. The system illustrated in FIG. 1 includes a plurality of rental vehicles 10 and a server apparatus 200 for managing those rental vehicles 10. Each rental vehicle 10 and the server apparatus 200 may be configured to be connectable to each other through a network.

The rental vehicles 10 may each be a vehicle that autonomously travels in accordance with a given operation command, or may be a vehicle that travels in accordance with a manual operation by a driver. In addition, the rental vehicles 10 may each be a vehicle that is driven by an internal combustion engine as a prime mover, or a vehicle that is driven by an electric motor as a prime mover, or an HV (hybrid vehicle) that is driven by an internal combustion engine and an electric motor as prime movers.

The server apparatus 200 manages a load history of each rental vehicle 10 under the management of the server apparatus 200, and a load tendency of each member (user) of the vehicle rental service. In addition, when a rental request is generated from a user (desired user) who desires to rent a rental vehicle 10, the server apparatus 200 selects a vehicle to be rented to the desired user (a renting vehicle) from among the rental vehicles 10 that are available for rent to the desired user. At this time, the server apparatus 200 selects a rental vehicle 10 having a load history matching the load tendency of the desired user among the rental vehicles 10 that are available for rent to the desired user. The server apparatus 200 having such a function corresponds to an “information processing apparatus” in the present disclosure. Here, note that in this example, a total travel distance is used as the load tendency of the user. In accompany with this, a cumulative travel distance is used as the load history of the rental vehicle 10.

(Hardware Configuration of Server Apparatus)

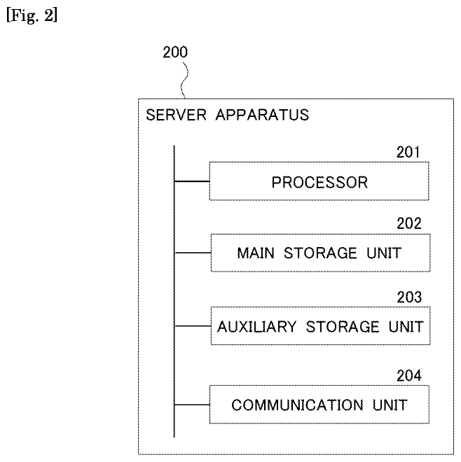

Here, an example of the hardware configuration of the server apparatus 200 is illustrated in FIG. 2. The server apparatus 200 has a configuration of a general computer. That is, the server apparatus 200 includes a processor 201, a main storage unit 202, an auxiliary storage unit 203, and a communication unit 204. These components are connected to one another by means of a bus. The main storage unit 202 and the auxiliary storage unit 203 are computer-readable recording media. The hardware configuration of the server apparatus 200 is not limited to the example illustrated in FIG. 2, and component elements may be omitted, replaced, or added as appropriate.

In the server apparatus 200, the processor 201 loads a program stored in a recording medium into a work area of the main storage unit 202 and executes the program, so that each functional configuration unit and the like are controlled through the execution of the program, thereby realizing a function matching a predetermined purpose.

The processor 201 is, for example, a CPU (central processing unit) or a DSP (digital signal processor). The processor 201 controls the server apparatus 200, and performs various information processing operations. The main storage unit 202 includes, for example, a RAM (random access memory) and a ROM (read only memory). The auxiliary storage unit 203 includes, for example, at least one of an EPROM (erasable programmable ROM) and a hard disk drive (HDD). In addition, the auxiliary storage unit 203 may include a removable medium, i.e., a portable recording medium. The removable medium is a disk recording medium such as, for example, a USB (universal serial bus) memory, a CD (compact disc), or a DVD (digital versatile disc).

The auxiliary storage unit 203 stores various kinds of programs, various kinds of data, and various kinds of tables in a recording medium in a readable and/or writable manner. In addition, the auxiliary storage unit 203 also stores an operating system (OS) and the like. Note that a part or all of these pieces of information may be stored in the main storage unit 202. Moreover, a part or all of the information stored in the main storage unit 202 may be stored in the auxiliary storage unit 203.

The communication unit 204 transmits and receives information between an external device and the server apparatus 200. The communication unit 204 is, for example, a LAN (Local Area Network) interface board or a wireless communication circuit for wireless communication. The server apparatus 200 is connected to a network through the LAN interface board or the wireless communication circuit. The network is, for example, a WAN (Wide Area Network), which is a worldwide public communication network such as the Internet, or other communication networks.

A series of processes executed by the server apparatus 200 configured as described above can be executed by hardware or software.

(Functional Configuration of Server Apparatus)

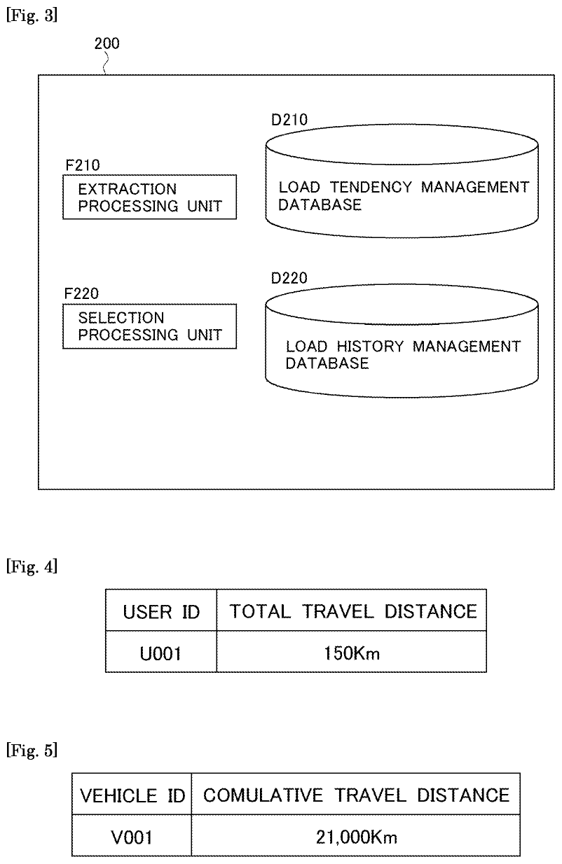

Next, the functional configuration of the server apparatus 200 will be described based on FIG. 3. As illustrated in FIG. 3, the server apparatus 200 according to this embodiment includes, as functional component elements, an extraction processing unit F210, a selection processing unit F220, a load tendency management database D210, and a load history management database D220. Here, the extraction processing unit F210 and the selection processing unit F220 are formed by executing a computer program on the main storage unit 202 by means of the processor 201 of the server apparatus 200. A combination of these extraction processing unit F210 and the selection processing unit F220 corresponds to a “controller” in the present disclosure. Note that either of the extraction processing unit F210 and the selection processing unit F220, or a part thereof may be formed by a hardware circuit. Also, the load tendency management database D210 and the load history management database D220 are built by a program of a database management system (DBMS) executed by the processor 201. Specifically, the above-mentioned two databases are built by managing the data stored in the auxiliary storage unit 203 by means of the program of the DBMS. These load tendency management database D210 and load history management database D220 are, for example, relational databases.

Here, note that any of the functional component elements of the server apparatus 200 or a part of the processes thereof may be executed by another computer connected thereto via a network. For example, each process included in the extraction processing unit F210 and each process included in the selection processing unit F220 may be executed by separate computers, respectively, connected to each other via a network.

In the load tendency management database D210, users who subscribe to a vehicle rental service are associated with the load tendencies of the users. Here, a configuration example of information stored in the load tendency management database D210 will be described based on FIG. 4. FIG. 4 is a view exemplifying a table configuration of the information stored in the load tendency management database D210. Note that the configuration of a table stored in the load tendency management database D210 (hereinafter, sometimes referred to as a “load tendency information table”) is not limited to the example illustrated in FIG. 4, but it is possible to add, change or delete a field(s) as appropriate. In addition, although FIG. 4 exemplifies the load tendency information table for one user, load tendency information tables for the number of users who subscribe to the vehicle rental service may be stored in the load tendency management database D210.

The load tendency information table illustrated in FIG. 4 has individual fields for user ID and total travel distance. In the user ID field, information for identifying each user (user ID) is registered. The user ID is, for example, a membership number assigned to each user when the user registers as a member of the vehicle rental service. In the total travel distance field, a cumulative total of distance traveled by the rental vehicle 10 when each user utilizes the rental vehicle 10 (i.e., a cumulative total of distance traveled by the rental vehicle 10 during a rental period per one time) is registered. Here, note that for a user who uses the vehicle rental service a plurality of times, an average value of the total travel distances in the plurality of uses is registered in the total travel distance field. The information registered in the total travel distance field is updated, for example, at the time when the user returns the rental vehicle 10. At this time, the information in the total travel distance field may be manually registered by an administrator of the rental vehicle 10. For example, the administrator may grasp the cumulative travel distance of the rental vehicle 10 (e.g., the travel distance displayed on an odometer) at each timing of the start and end of use of the rental vehicle 10 by the user. Then, the administrator may calculate a difference between the two cumulative travel distances, and input the difference as a total travel distance to the total travel distance field. In addition, the information in the total travel distance field may be automatically registered by the server apparatus 200. For example, the server apparatus 200 may communicate with the rental vehicle 10 at each timing of the start of use and the end of use of the rental vehicle 10 by the user, whereby the cumulative travel distance at the start of use and the cumulative travel distance at the end of use can be obtained. Then, the server apparatus 200 may calculate a difference between the two cumulative travel distances, and register the difference in the total travel distance field as the total travel distance. Note that, as described above, the cumulative travel distance is the cumulative travel distance of the rental vehicle 10 from the time the vehicle was new.

The load tendency management database D210 storing the load tendency information table as described above corresponds to a “first storage” in the present disclosure.

Subsequently, in the load history management database D220, the rental vehicles 10 under the management of the server apparatus 200 are associated with the load histories of the rental vehicles 10. Here, a configuration example of the information stored in the load history management database D220 will be described based on FIG. 5. FIG. 5 is a view exemplifying a table configuration of the information stored in the load history management database D220. Here, note that the configuration of the table stored in the load history management database D220 (hereinafter, also sometimes referred to as a “load history information table”) is not limited to the example illustrated in FIG. 5, but it is possible to add, change, or delete a field(s) as appropriate. Also, in FIG. 5, the load tendency information table for one vehicle is exemplified, but load history information tables for the number of rental vehicles 10 under the management of the server apparatus 200 are stored in the load history management database D220.

The load history information table illustrated in FIG. 5 has fields for a vehicle ID and a cumulative travel distance. In the vehicle ID field, there is registered information for identifying each vehicle (vehicle ID). The vehicle ID is, for example, information given when a vehicle is registered as a rental vehicle for a vehicle rental service. The cumulative travel distance of each rental vehicle 10 is registered in the cumulative travel distance field. The information registered in the cumulative travel distance field is updated, for example, at the timing when the rental vehicle 10 has been returned. At this time, the information in the cumulative travel distance field may be updated manually by the administrator of the rental vehicle 10, or may be updated automatically by the server apparatus 200.

The load history management database D220 storing the load history information tables as described above corresponds to a “second storage” in the present disclosure.

Then, when a rental request is generated from a desired user, the extraction processing unit F210 extracts the load tendency of the desired user and the load histories of the rental vehicles 10 that are available for rent to the desired user. Specifically, the extraction processing unit F210 first accesses the load tendency management database D210 based on the user ID of the desired user thereby to specify a load tendency information table corresponding to the user ID of the desired user. Subsequently, the extraction processing unit F210 extracts information (total travel distance) registered in the total travel distance field of the specified load tendency information table. In addition, the extraction processing unit F210 specifies rental vehicles 10 available for rent in a rental period desired by the desired user. Such a process of identifying the rental vehicles 10 can be performed by using a known method. For example, among the rental vehicles 10 under the management of the server apparatus 200, those rental vehicles 10 for which a rental reservation to another user has not been made in the rental period desired by the desired user should only be specified. Then, the extraction processing unit F210 accesses the load history management database D220 based on the vehicle IDs of the rental vehicles 10 available for rent thereby to specify the load history information tables corresponding to the vehicle IDs of the rental vehicles 10 available for rent. Subsequently, the extraction processing unit F210 extracts information (cumulative travel distances) registered in the load history fields of the specified load history information tables. The load tendency (total travel distance) and the load histories (cumulative travel distances) extracted by the extraction processing unit F210 are passed to the selection processing unit F220. At this time, the load histories (cumulative travel distances) are passed to the selection processing unit F220 in a form associated with the vehicle IDs of the rental vehicles 10 available for rent.

The selection processing unit F220 selects a renting vehicle from the rental vehicles 10 available for rent, by comparing the load tendency (total travel distance) of the desired user with the load histories (cumulative travel distances) of the rental vehicles 10 available for rent. In this example, if the total travel distance of the desired user is larger than a predetermined threshold value, the selection processing unit F220 selects, as the renting vehicle, a rental vehicle 10 having the smallest cumulative travel distance among the rental vehicles 10 available for rent. On the other hand, when the total travel distance of the desired user is equal to or less than the predetermined threshold value, the selection processing unit F220 selects, as the renting vehicle, a rental vehicle 10 having the largest cumulative travel distance among the rental vehicles 10 available for rent. The “predetermined threshold value” referred to here may be a value statistically determined in advance, or may be an average value of the total travel distances of all users.

Here, note that the following method may be adopted as another method of selecting a renting vehicle from among the rental vehicles 10 available for rent. That is, the total travel distances of the individual users may be ranked into three levels of “large”, “medium”, and “small” in descending order, and the cumulative travel distances of the individual rental vehicles 10 may also be ranked into three levels of “large”, “medium”, and “small” in descending order. Then, the selection processing unit F220 may select a vehicle to be rented to the desired user in any of the following procedures (1) through (3).

(1) In cases where the rank of the desired user is “large”, a rental vehicle 10 of the rank “small” is selected as the renting vehicle.

(2) In cases where the rank of the desired user is “medium”, a rental vehicle 10 of the rank “medium” is selected as the renting vehicle.

(3) In cases where the rank of the desired user is “small”, a rental vehicle 10 of the rank “large” is selected as the renting vehicle.

Here, note that the ranking of the user and the rental vehicle 10 is not limited to the three levels, but may be four or more levels.

When the renting vehicle is selected by the above-described method, the cumulative travel distance of a specific rental vehicle 10 is suppressed from becoming significantly longer than those of the other rental vehicles 10. In other words, the load related to driving or travel performance is suppressed from concentrating on the specific rental vehicle 10.

(Processing Flow)

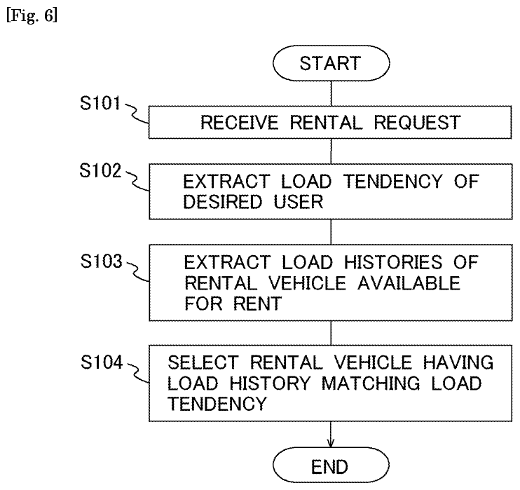

Next, a flow of processing to be performed by the server apparatus 200 in this example will be described based on FIG. 6. FIG. 6 is a flowchart illustrating the flow of processing performed by the server apparatus 200 at the time when a rental request from a desired user is generated.

In FIG. 6, first, the server apparatus 200 receives a rental request from a desired user (step S101). At this time, the rental request includes information indicating the user ID of the desired user and information indicating the rental period desired by the desired user. When the server apparatus 200 receives such a rental request, the extraction processing unit F210 extracts the load tendency (total travel distance) of the desired user (step S102). Specifically, the extraction processing unit F210 first accesses the load tendency management database D210 based on the user ID of the desired user thereby to specify a load tendency information table corresponding to the desired user. Then, the extraction processing unit F210 extracts the load tendency (total travel distance) stored in the total travel distance field of the load table corresponding to the desired user.

In addition, the extraction processing unit F210 extracts the load history (cumulative travel distance) of each of the rental vehicles 10 that are available for rent to the desired user (step S103). Specifically, the extraction processing unit F210 first specifies the rental vehicles 10 that are available for rent in the rental period desired by the desired user. Subsequently, the extraction processing unit F210 accesses the load history management database D220 based on the vehicle ID of each of the rental vehicles 10 available for rent thereby to specify a load history information table corresponding to each of the rental vehicles 10 available for rent. Then, the extraction processing unit F210 extracts information (cumulative travel distance) registered in the load history field of each of the load history information tables thus specified.

When the load tendency of the desired user and the load history of each of the rental vehicles 10 available for rent are extracted by the extraction processing unit F210, the selection processing unit F220 selects a renting vehicle (step S104). That is, the selection processing unit F220 selects a rental vehicle 10 having a load history matching the load tendency of the desired user from the rental vehicles 10 available for rent. In this example, the processing of step S104 is performed according to a processing flow as illustrated in FIG. 7. That is, the selection processing unit F220 determines whether or not the total travel distance of the desired user is larger than a predetermined threshold value (step S1041). As described above, the “predetermined threshold value” in this example is a value statistically determined in advance, or an average value of the total travel distances of all users. When the total travel distance of the desired user is larger than the predetermined threshold value (i.e., an affirmative determination in step S1041), the selection processing unit F220 selects, as the renting vehicle, a rental vehicle 10 having the smallest cumulative travel distance among the rental vehicles 10 available for rent (step S1042). On the other hand, when the total travel distance of the desired user is equal to or less than the predetermined threshold value (i.e., a negative determination in step S1041), the selection processing unit F220 selects, as the renting vehicle, a rental vehicle 10 having the largest cumulative travel distance among the rental vehicles 10 available for rent (step S1043).

According to the processing flows of FIGS. 6 and 7, it is possible to rent the rental vehicle 10 having the load history matching the load tendency of the desired user to the desired user. That is, in the case where the total travel distance of the desired user is large, it is possible to rent the rental vehicle 10 having a smaller cumulative travel distance to the desired user, as compared with the case where the total travel distance is small. With this, the cumulative travel distance of a specific rental vehicle 10 is suppressed from becoming significantly longer than those of the other rental vehicles 10. In other words, it is possible to suppress the load related to the travel performance from concentrating on the specific rental vehicle 10. As a result, the service life of the specific rental vehicle 10 is suppressed from becoming significantly shorter than those of the other rental vehicles 10.

### Second Embodiment

Next, a second embodiment of the information processing apparatus according to the present disclosure will be described based on FIGS. 8 through 10. Here, a detailed description of substantially the same configuration and substantially the same control processing as in the first embodiment described above will be omitted.

A difference between the aforementioned first embodiment and this second embodiment is that a continuous travel distance is used as the load tendency of each user, instead of a total travel distance thereof, and a continuous travel distance is used as the load history of each rental vehicle 10, instead of a cumulative travel distance thereof.

Here, as the number of times of continuous traveling over a relatively long distance in a specific rental vehicle 10 increases, the degradation of the rental vehicle 10 may proceed. In addition, as the number of times that a specific rental vehicle 10 continuously travels an extremely short distance increases, the degradation of the rental vehicle 10 may proceed. Therefore, when the number of times of continuous traveling over a relatively long distance or the number of times of continuous traveling over an extremely short distance is biased to a specific rental vehicle 10, the service life of the specific rental vehicle 10 may be significantly shortened, as compared with the other rental vehicles 10. Accordingly, in this second embodiment, a rental vehicle 10 having a load history in which the continuous travel distance is shorter is rented to a user having a load tendency in which the continuous travel distance is long, as compared with a user having a load tendency in which the continuous travel distance is short.

Here, note that the “continuous travel distance” in this example is, for example, a distance traveled by a rental vehicle 10 during a period of time from when an ignition switch (a start switch of a prime mover) is turned on to when it is turned off.

FIG. 8 is a view illustrating a configuration example of a load tendency information table stored in the load tendency management database D210 in this embodiment. The configuration of the load tendency information table is not limited to the example illustrated in FIG. 8, but a field(s) can be added, changed, or deleted as appropriate. The load tendency information table in this example has fields for a user ID and a continuous travel distance. In the user ID field, there is registered a user ID for identifying each user. In the continuous travel distance field, there is registered a distance continuously traveled by the rental vehicle 10 when each user uses the rental vehicle 10 (i.e., an average value or a maximum value of the distance continuously traveled by the rental vehicle 10 during a rental period per one time). Here, note that for a user who uses the vehicle rental service a plurality of times, an average value or a maximum value of the continuous travel distance in the plurality of uses is registered in the continuous travel distance field. Also, note that the continuous travel distance is recorded by an ECU or the like mounted on each rental vehicle 10. Then, the administrator of the rental vehicles 10 or the server apparatus 200 reads out the continuous travel distance from the ECU or the like when the user finishes using the rental vehicle 10, and updates the information in the continuous travel distance field with the information thus read out.

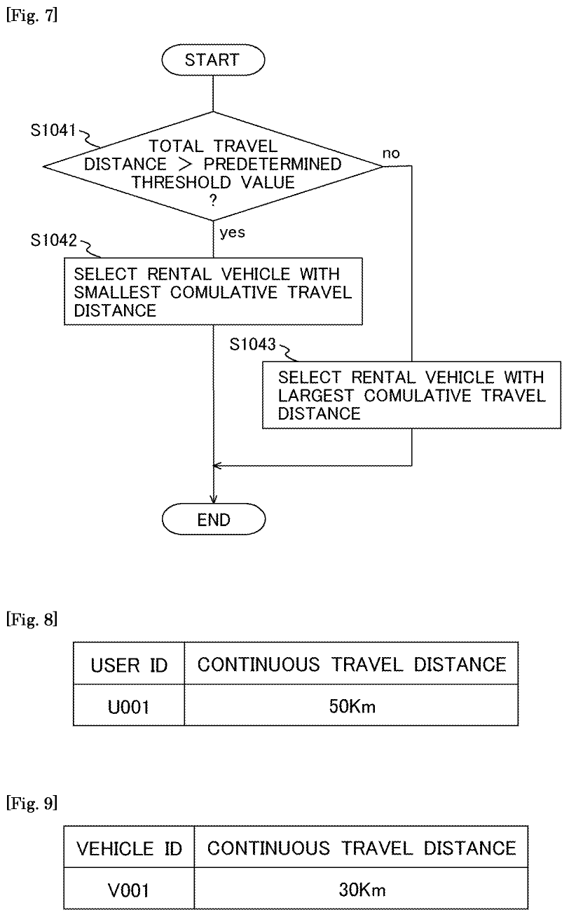

FIG. 9 is a view illustrating a configuration example of a load history information table stored in the load history management database D220 in this embodiment. The configuration of the load history information table is not limited to the example shown in FIG. 9, and a field(s) can be added, changed, or deleted as appropriate. The load history information table in this example has fields for a vehicle ID and a continuous travel distance. In the vehicle ID field, there is registered a vehicle ID for identifying each rental vehicle 10. In the continuous travel distance field, there is registered a distance that each rental vehicle 10 is caused to travel continuously when rented out (i.e., an average value or a maximum value of the distances that the individual rental vehicles 10 are caused to travel continuously during the rental period per one time). Here, note that for a rental vehicle 10 whose number of times of renting is plural, an average value or a maximum value of the continuous travel distances in the plurality of times of renting is registered in the continuous travel distance field.

When a rental request is generated from a desired user, the extraction processing unit F210 in this example extracts, as the load tendency of the desired user, the information (continuous travel distance) registered in the continuous travel distance field of the load tendency information table corresponding to the desired user. The extraction processing unit F210 extracts, as the load histories of the rental vehicles 10 available for rent, the information (continuous travel distances) registered in the continuous travel distance fields of the load history information tables corresponding to the rental vehicles 10 available for rent.

The selection processing unit F220 in this example compares the continuous travel distance of the desired user with the continuous travel distances of the rental vehicles 10 available for rent thereby to select a renting vehicle from among the rental vehicles 10 available for rent. In this example, if the continuous travel distance of the desired user is larger than a predetermined threshold value, the selection processing unit F220 selects, as the renting vehicle, a rental vehicle 10 having the smallest continuous travel distance among the rental vehicles 10 available for rent. On the other hand, if the continuous travel distance of the desired user is equal to or less than the predetermined threshold value, the selection processing unit F220 selects, as the renting vehicle, a rental vehicle 10 having the largest continuous travel distance among the rental vehicles 10 available for rent. The “predetermined threshold value” referred to here may be a value statistically determined in advance, or may be an average value of the continuous travel distances of all users.

Here, note that the following method may be adopted as another method of selecting a renting vehicle from among the rental vehicles 10 available for rent. That is, the continuous travel distances of the individual users may be ranked into three levels of “large”, “medium”, and “small” in descending order, and the continuous travel distances of the individual rental vehicles 10 may also be ranked into three levels of “large”, “medium”, and “small” in descending order. Then, the selection processing unit F220 may select a vehicle to be rented to the desired user in any of the following procedures (4) through (6).

(4) In cases where the rank of the desired user is “large”, a rental vehicle 10 of the rank “small” is selected as the renting vehicle.

(5) In cases where the rank of the desired user is “medium”, a rental vehicle 10 of the rank “medium” is selected as the renting vehicle.

(6) In cases where the rank of the desired user is “small”, a rental vehicle 10 of the rank “large” is selected as the renting vehicle.

Here, note that the ranking of the user and the rental vehicle 10 is not limited to the three levels, but may be four or more levels.

When the renting vehicle is selected by the method described above, a specific rental vehicle 10 will be suppressed from becoming significantly larger than other rental vehicles 10 in terms of the number of times the vehicle is continuously driven over a relatively long distance or the number of times the vehicle is continuously driven over an extremely short distance. In other words, the load related to driving or travel performance is suppressed from concentrating on the specific rental vehicle 10.

(Processing Flow)

Next, a flow of processing to be performed by the server apparatus 200 in this example will be described. The server apparatus 200 of this example selects a renting vehicle in the same procedure as described in FIG. 6, when a rental request from the desired user is generated. However, in step S102, as the load tendency of the desired user, the continuous travel distance thereof is extracted instead of the total travel distance. Also, in step S103, as the load histories of the rental vehicles 10 available for rent, the continuous travel distances thereof are extracted instead of the cumulative travel distances. Then, in step S104, the processing flow of FIG. 10 is carried out instead of the above-mentioned flow of FIG. 7.

In the processing flow of FIG. 10, the selection processing unit F220 determines whether the continuous travel distance of the desired user is larger than a predetermined threshold value (step S2041). As described above, the “predetermined threshold value” in this example is a value statistically determined in advance, or an average value of the continuous travel distances of all users. When the continuous travel distance of the desired user is larger than the predetermined threshold value (i.e., an affirmative determination in step S2041), the selection processing unit F220 selects, as the renting vehicle, a rental vehicle 10 having the smallest continuous travel distance among the rental vehicles 10 available for rent (step S2042). On the other hand, when the continuous travel distance of the desired user is equal to or less than the predetermined threshold value (i.e., a negative determination in step S2041), the selection processing unit F220 selects, as the renting vehicle, a rental vehicle 10 having the largest continuous travel distance among the rental vehicles 10 available for rent (step S2043).

According to the processing flow of FIG. 10, in the case where the continuous travel distance of the desired user is large, it is possible to rent the rental vehicle 10 having a smaller continuous travel distance to the desired user, as compared with the case where the continuous travel distance is small. This serves to suppress the number of times the vehicle is continuously driven over a relatively long distance or over an extremely short distance from being biased to a specific rental vehicle 10. In other words, it is possible to suppress the load related to the travel performance from concentrating on the specific rental vehicle 10. As a result, the service life of the specific rental vehicle 10 is suppressed from becoming significantly shorter than those of the other rental vehicles 10.

### Third Embodiment

A third embodiment of the information processing apparatus according to the present disclosure will be described based on FIGS. 11 through 13. Here, a detailed description of substantially the same configuration and substantially the same control processing as in the first embodiment described above will be omitted.

A difference between the aforementioned first embodiment and this third embodiment is that a battery consumption amount is used as the load tendency of each user, instead of a total travel distance thereof, and a battery full charge amount is used as the load history of each rental vehicle 10, instead of a cumulative travel distance thereof. The “battery” referred to in this example is a battery for driving a rental vehicle 10. Therefore, the information processing apparatus (server apparatus) in this example is effective when the rental vehicle 10 is a vehicle that is driven by making use of battery power (an EV (electric vehicle), PHV (plug-in hybrid vehicle) or the like). Here, note that the “battery consumption amount” is a cumulative total of amount of battery consumption of the rental vehicle 10 during a rental period per one time. Also, the “full charge amount of the battery” is a discharge capacity of the battery when the battery is in a fully charged state (i.e., a state in which the battery cannot be charged any more).

Here, the battery tends to degrade as the number of battery charges thereof increases. Accordingly, the full charge amount of the battery tends to decrease as the number of battery charges increases. Therefore, if vehicles to be rented to users having a load tendency of consuming a large amount of battery power are biased toward a specific rental vehicle 10, the number of battery charges of the specific rental vehicle 10 will increase, as a result of which there will be a possibility that the battery degradation of the specific rental vehicle 10 increases significantly as compared to other rental vehicles 10. As a result, the degree of degradation of the battery of the specific rental vehicle may become significantly larger than those of other rental vehicles 10. In other words, the full charge amount of the battery in the specific rental vehicle 10 may become significantly smaller than those of other rental vehicles 10. Accordingly, in this third embodiment, a rental vehicle 10 with a larger full charge amount of its battery is rented to a user having a load tendency in which the battery consumption amount is large, as compared with a user having a load tendency in which the battery consumption amount is small. Stated in another way, a rental vehicle 10 having a load history in which the degree of degradation of the battery is smaller is rented to a user having a load tendency in which the battery consumption amount is large, as compared with a user having a load tendency in which the battery consumption amount is small.

FIG. 11 is a view illustrating a configuration example of a load tendency information table stored in the load tendency management database D210 in this embodiment. The configuration of the load tendency information table is not limited to the example illustrated in FIG. 11, but a field(s) can be added, changed, or deleted as appropriate. The load tendency information table in this example has fields for a user ID and a battery consumption amount. In the user ID field, there is registered a user ID for identifying each user. In the battery consumption amount field, a cumulative total of amount of battery consumption of a rental vehicle 10 when each user utilizes the rental vehicle 10 (i.e., a cumulative total of amount of battery consumption of the rental vehicle 10 during the rental period per one time) is registered. Here, note that for a user who uses the vehicle rental service a plurality of times, an average value or a maximum value of the battery consumption amount in the plurality of uses is registered in the battery consumption amount field. Also, note that the battery consumption amount is recorded by an ECU or the like mounted on each rental vehicle 10. Then, the administrator of the rental vehicles 10 or the server apparatus 200 reads out the battery consumption amount from the ECU or the like when the user finishes using the rental vehicle 10, and updates the information in the battery consumption amount field with the information thus read out.

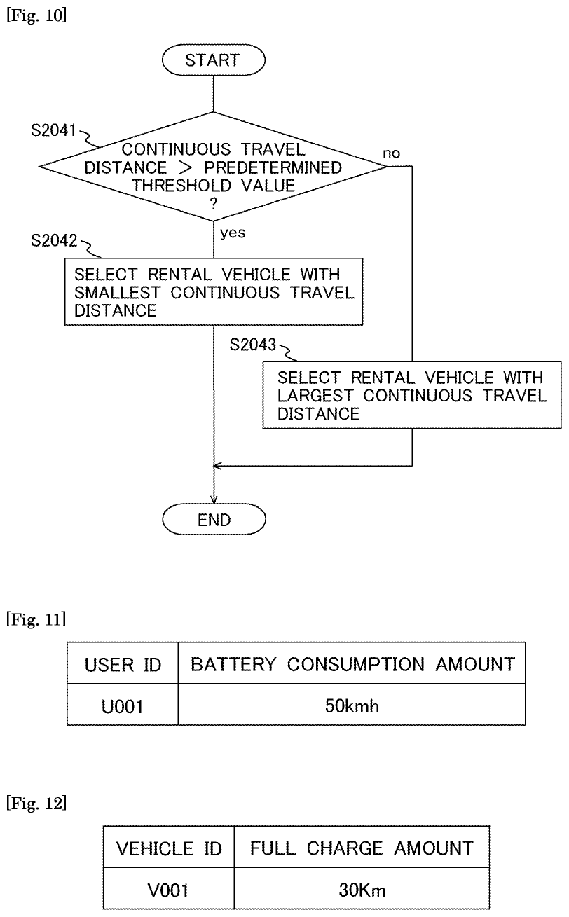

FIG. 12 is a view illustrating a configuration example of a load history information table stored in the load history management database D220 in this embodiment. The configuration of the load history information table is not limited to the example shown in FIG. 12, and a field(s) can be added, changed, or deleted as appropriate. The load history information table in this example has fields for a vehicle ID and a full charge amount. In the vehicle ID field, there is registered a vehicle ID for identifying each rental vehicle 10. The full charge amount of the battery of each rental vehicle 10 is registered in the full charge amount field.

When a rental request is generated from a desired user, the extraction processing unit F210 in this example extracts, as the load tendency of the desired user, the information (battery consumption amount) registered in the battery consumption amount field of the load tendency information table corresponding to the desired user. Also, the extraction processing unit F210 extracts, as the load histories of the rental vehicles 10 available for rent, the information (the full charge amounts of the batteries) registered in the battery consumption amount fields of the load history information tables corresponding to the rental vehicles 10 available for rent.

The selection processing unit F220 in this example compares the battery consumption amount of the desired user with the full charge amounts of the batteries of the rental vehicles 10 available for rent thereby to select a renting vehicle from among the rental vehicles 10 available for rent. In this example, if the battery consumption amount of the desired user is larger than a predetermined threshold value, the selection processing unit F220 selects, as the renting vehicle, a rental vehicle 10 having the largest full charge amount of the battery among the rental vehicles 10 available for rent. On the other hand, if the battery consumption amount of the desired user is equal to or less than the predetermined threshold value, the selection processing unit F220 selects, as the renting vehicle, a rental vehicle 10 having the smallest full charge amount of the battery among the rental vehicles 10 available for rent. The “predetermined threshold value” referred to here may be a value statistically determined in advance, or may be an average value of the battery consumption amounts of all users.

Here, note that the following method may be adopted as another method of selecting a renting vehicle from among the rental vehicles 10 available for rent. That is, the battery consumption amounts of the individual users may be ranked into three levels of “large”, “medium”, and “small” in descending order, and the full charge amounts of the batteries of the individual rental vehicles 10 may also be ranked into three levels of “large”, “medium”, and “small” in descending order. Then, the selection processing unit F220 may select a vehicle to be rented to the desired user in any of the following procedures (7) through (9).

(7) In cases where the rank of the desired user is “large”, a rental vehicle 10 of the rank “large” is selected as the renting vehicle.

(8) In cases where the rank of the desired user is “medium”, a rental vehicle 10 of the rank “medium” is selected as the renting vehicle.

(9) In cases where the rank of the desired user is “small”, a rental vehicle 10 of the rank “small” is selected as the renting vehicle.

Here, note that the ranking of the user and the rental vehicle 10 is not limited to the three levels, but may be four or more levels.

When the renting vehicle is selected by the above-described method, the number of battery charges of a specific rental vehicle 10 is suppressed from significantly larger than those of the other rental vehicles 10. In other words, the load related to driving or travel performance is suppressed from concentrating on the specific rental vehicle 10.

(Processing Flow)

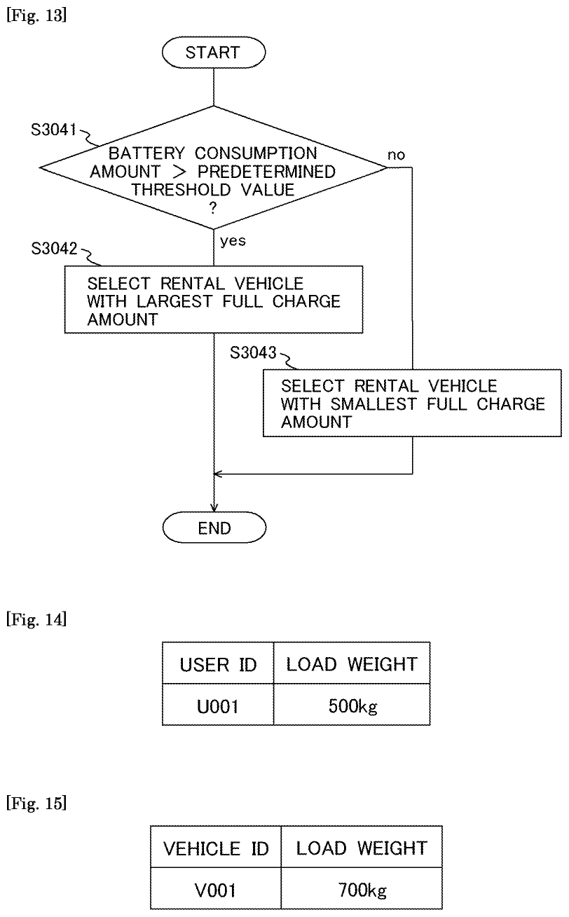

Next, a flow of processing to be performed by the server apparatus 200 in this example will be described. The server apparatus 200 of this example selects a renting vehicle in the same procedure as described in FIG. 6, when a rental request from the desired user is generated. However, in step S102, as the load tendency of the desired user, the battery consumption amount thereof is extracted instead of the total travel distance. Also, in step S103, as the load histories of the rental vehicles 10 available for rent, the full charge amounts of the batteries thereof are extracted instead of the cumulative travel distances. Then, in step S104, the processing flow of FIG. 13 is carried out instead of the above-mentioned flow of FIG. 7.

In the processing flow of FIG. 13, the selection processing unit F220 determines whether the battery consumption amount of the desired user is larger than a predetermined threshold value (step S3041). As described above, the “predetermined threshold value” in this example is a value statistically determined in advance, or an average value of the battery consumption amounts of all users. Then, when the battery consumption amount of the desired user is larger than the predetermined threshold value (i.e., an affirmative determination in step S3041), the selection processing unit F220 selects, as the renting vehicle, a rental vehicle 10 having the largest full charge amount of the battery among the rental vehicles 10 available for rent (step S3042). On the other hand, when the battery consumption amount of the desired user is equal to or less than the predetermined threshold value (i.e., a negative determination in step S3041), the selection processing unit F220 selects, as the renting vehicle, a rental vehicle 10 having the smallest full charge amount of the battery among the rental vehicles 10 available for rent (step S3043).

According to the processing flow of FIG. 13, in the case where the battery consumption amount of the desired user is large, it is possible to rent the rental vehicle 10 having a larger full charge amount of the battery to the desired user, as compared with the case where the battery consumption amount is small. With this, the number of battery charges of a specific rental vehicle 10 is suppressed from significantly larger than those of the other rental vehicles 10. In other words, the degree of degradation of the battery of the specific rental vehicle 10 will be suppressed from becoming significantly larger than those of other rental vehicles. As a result, the service life of the specific rental vehicle 10 is suppressed from becoming significantly shorter than those of the other rental vehicles 10.

Here, note that, in this embodiment, an example using a battery consumption amount as the load tendency of each user has been explained, but the number of battery charges may instead be used as the load tendency of each user. In that case, in the case where the number of battery charges of a desired user is large, a rental vehicle 10 having a larger full charge amount of its battery need only be selected as a renting vehicle, in comparison with the case where the number of battery charges is small.

### Fourth Embodiment

A fourth embodiment of the information processing apparatus according to the present disclosure will be described based on FIGS. 14 through 16. Here, a detailed description of substantially the same configuration and substantially the same control processing as in the first embodiment described above will be omitted.

A difference between the aforementioned first embodiment and this second embodiment is that a load weight is used as the load tendency of each user, instead of a total travel distance thereof, and a load weight is also used as the load history of each rental vehicle 10, instead of a cumulative travel distance thereof.

Here, as the number of times relatively heavy loads are loaded in a specific rental vehicle 10 increases, the body or suspension of the specific rental vehicle 10 may be degraded. Therefore, when the number of times relatively heavy loads are loaded is biased to a specific rental vehicle 10, the service life of the specific rental vehicle 10 may be significantly shortened, as compared with those of the other rental vehicles 10. Accordingly, in this fourth embodiment, a rental vehicle 10 having a load history in which the load weight is smaller is rented to a user having a load tendency in which the load weight is large, as compared with a user having a load tendency in which the load weight is small.

FIG. 14 is a view illustrating a configuration example of a load tendency information table stored in the load tendency management database D210 in this embodiment. The configuration of the load tendency information table is not limited to the example illustrated in FIG. 14, but a field(s) can be added, changed, or deleted as appropriate. The load tendency information table in this example has fields for a user ID and a load weight. In the user ID field, there is registered a user ID for identifying each user. In the load weight field, there is registered the weight of a load loaded on a rental vehicle 10 when each user uses the rental vehicle 10 (i.e., an average value or a maximum value of the weight of the load loaded on the rental vehicle 10 during a rental period per one time). Here, note that for a user who uses the vehicle rental service a plurality of times, an average value or a maximum value of the load weights in the plurality of uses is registered in the load weight field. Also, note that the load weights are detected by a weight sensor mounted on each rental vehicle 10, and recorded by an ECU or the like mounted thereon. Then, the administrator of the rental vehicles 10 or the server apparatus 200 reads out the load weight from the ECU or the like when the user finishes using the rental vehicle 10, and updates the information in the load weight field with the information thus read out.

FIG. 15 is a view illustrating a configuration example of a load history information table stored in the load history management database D220 in this embodiment. The configuration of the load history information table is not limited to the example shown in FIG. 15, and a field(s) can be added, changed, or deleted as appropriate. The load history information table in this example has fields for a vehicle ID and a load weight. In the vehicle ID field, there is registered a vehicle ID for identifying each rental vehicle 10. In the load weight field, there is registered the weight of a load loaded on each rental vehicle 10 when the rental vehicle 10 is rented out (i.e., an average value or a maximum value of the weight of the load loaded on the rental vehicle 10 during the rental period per one time). Here, note that for a rental vehicle 10 whose number of times of renting is plural, an average value or a maximum value of the load weights in the plurality of times of renting is registered in the load weight field.

When a rental request is generated from a desired user, the extraction processing unit F210 in this example extracts, as the load tendency of the desired user, the information (load weight) registered in the load weight field of the load tendency information table corresponding to the desired user. Also, the extraction processing unit F210 extracts, as the load histories of the rental vehicles 10 available for rent, the information (the load weights) registered in the load weight fields of the load history information tables corresponding to the rental vehicles 10 available for rent.

The selection processing unit F220 in this example compares the load weight of the desired user with the load weights of the rental vehicles 10 available for rent thereby to select a renting vehicle from among the rental vehicles 10 available for rent. In this example, if the load weight of the desired user is larger than a predetermined threshold value, the selection processing unit F220 selects, as the renting vehicle, a rental vehicle 10 having the smallest load weight among the rental vehicles 10 available for rent. On the other hand, when the load weight of the desired user is equal to or less than the predetermined threshold value, the selection processing unit F220 selects, as the renting vehicle, a rental vehicle 10 having the largest load weight among the rental vehicles 10 available for rent. The “predetermined threshold value” referred to here may be a value statistically determined in advance, or may be an average value of the load weights of all users.

Here, note that the following method may be adopted as another method of selecting a renting vehicle from among the rental vehicles 10 available for rent. That is, the load weights of the individual users may be ranked into three levels of “large”, “medium”, and “small” in descending order, and the load weights of the individual rental vehicles 10 may also be ranked into three levels of “large”, “medium”, and “small” in descending order. Then, the selection processing unit F220 may select a vehicle to be rented to the desired user in any of the following procedures (10) through (12).

(10) In cases where the rank of the desired user is “large”, a rental vehicle 10 of the rank “small” is selected as the renting vehicle.

(11) In cases where the rank of the desired user is “medium”, a rental vehicle 10 of the rank “medium” is selected as the renting vehicle.

(12) In cases where the rank of the desired user is “small”, a rental vehicle 10 of the rank “large” is selected as the renting vehicle.

Here, note that the ranking of the user and the rental vehicle 10 is not limited to the three levels, but may be four or more levels.

When the renting vehicle is selected by the method described above, a specific rental vehicle 10 will be suppressed from becoming significantly larger than other rental vehicles 10 in terms of the number of times the vehicle has been loaded with relatively heavy loads. In other words, the load related to driving or travel performance is suppressed from concentrating on the specific rental vehicle 10.

(Processing Flow)

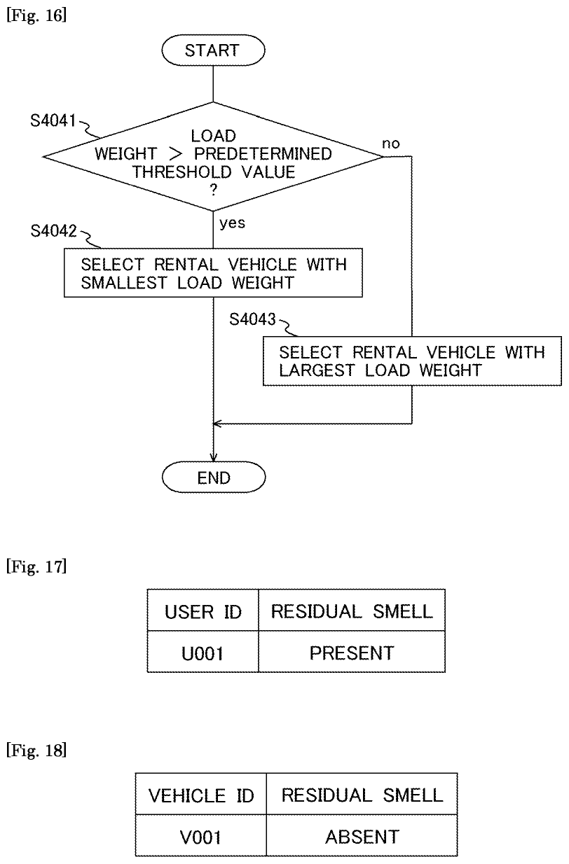

Next, a flow of processing to be performed by the server apparatus 200 in this example will be described. The server apparatus 200 of this example selects a renting vehicle in the same procedure as described in FIG. 6, when a rental request from the desired user is generated. However, in step S102, as the load tendency of the desired user, the load weight thereof is extracted instead of the total travel distance. Also, in step S103, as the load histories of the rental vehicles 10 available for rent, the load weights thereof are extracted instead of the cumulative travel distances. Then, in step S104, the processing flow of FIG. 16 is carried out instead of the above-mentioned flow of FIG. 7.

In the processing flow of FIG. 16, the selection processing unit F220 determines whether the load weight of the desired user is larger than a predetermined threshold value (step S4041). As described above, the “predetermined threshold value” in this example is a value statistically determined in advance, or an average value of the load weights of all users. When the load weight of the desired user is larger than the predetermined threshold value (i.e., an affirmative determination in step S4041), the selection processing unit F220 selects, as the renting vehicle, a rental vehicle 10 having the smallest load weight among the rental vehicles 10 available for rent (step S4042). On the other hand, when the load weight of the desired user is equal to or less than the predetermined threshold value (i.e., a negative determination in step S4041), the selection processing unit F220 selects, as the renting vehicle, a rental vehicle 10 having the largest load weight among the rental vehicles 10 available for rent (step S4043).

According to the processing flow of FIG. 16, in the case where the load weight of the desired user is large, it is possible to rent the rental vehicle 10 having a smaller load weight to the desired user, as compared with the case where the load weight is small. This serves to suppress the number of times a vehicle is loaded with loads of relatively heavy weights from being biased to a specific rental vehicle 10. In other words, it is possible to suppress the load related to the travel performance from concentrating on the specific rental vehicle 10. As a result, the service life of the specific rental vehicle 10 is suppressed from becoming significantly shorter than those of the other rental vehicles 10.

### Fifth Embodiment

A fifth embodiment of the information processing apparatus according to the present disclosure will be described based on FIGS. 17 through 19. Here, a detailed description of substantially the same configuration and substantially the same control processing as in the first embodiment described above will be omitted.

A difference between the aforementioned first embodiment and this fifth embodiment is that the presence or absence of a residual smell is used as the load tendency of each user, instead of a total travel distance thereof, and the presence or absence of a residual smell is also used as the load history of each rental vehicle 10, instead of a cumulative travel distance thereof. The “residual smell” referred to herein is a smell that remains in the interior of the rental vehicle 10 after the end of a rental period (e.g., a smell of cigarettes, or a smell of pets, etc.).

Here, if a user smokes a cigarette in the room of the rental vehicle 10 when the user utilizes the rental vehicle 10, or if the user has a pet riding in the room of the rental vehicle 10, the smell of the cigarette or the pet may remain in the room even after the end of the rental period. If a rental vehicle 10 with such a smell remaining therein is rented out to a user who does not smoke or a user who does not have a pet, the comfort of those users may be compromised. Accordingly, in this embodiment, for a user having a load tendency with the presence of a residual smell, a rental vehicle 10 having a load history with the presence of a residual smell is rented. On the other hand, for a user having a load tendency with the absence of a residual smell, a rental vehicle 10 having a load history with the absence of a residual smell is rented.

FIG. 17 is a view illustrating a configuration example of a load tendency information table stored in the load tendency management database D210 in this embodiment. The configuration of the load tendency information table is not limited to the example illustrated in FIG. 17, but a field(s) can be added, changed, or deleted as appropriate. The load tendency information table in this example has fields for a user ID and a residual smell. In the user ID field, there is registered a user ID for identifying each user. In the residual smell field, information indicating whether a smell such as the smell of a cigarette, a pet or the like has remained in the interior of a rental vehicle 10 when each user utilizes the rental vehicle 10 is registered. For example, for a user who has left the smell of a cigarette, a pet or the like in the interior of the rental vehicle 10, a “presence” is registered in the residual smell field. In addition, for a user who has not left the smell of a cigarette, a pet or the like in the interior of the rental vehicle 10, an “absence” is registered in the residual smell field. Here, note that the information in the residual smell field is inputted by the administrator of the rental vehicle 10. For example, when each user returns the rental vehicle 10, the administrator checks the presence or absence of a residual smell, and registers the result thereof into the residual smell field.

FIG. 18 is a view illustrating a configuration example of a load history information table stored in the load history management database D220 in this embodiment. The configuration of the load history information table is not limited to the example shown in FIG. 18, and a field(s) can be added, changed, or deleted as appropriate. The load history information table in this example has fields for a vehicle ID and a residual smell. In the vehicle ID field, there is registered a vehicle ID for identifying each rental vehicle 10. In the residual smell field, information indicating whether a smell such as the smell of a cigarette, a pet or the like has remained in the interior of each rental vehicle 10 when each rental vehicle 10 is rented out. For example, for a rental vehicle 10 in the interior of which there has remained the smell of a cigarette, a pet or the like, a “presence” is registered in the residual smell field. On the other hand, for a rental vehicle 10 in the interior of which there has not remained the smell of a cigarette, a pet or the like, an “absence” is registered in the residual smell field. The information in the residual smell field is inputted by the administrator of the rental vehicle 10, as in the residual smell field of the load tendency information table.

When a rental request is generated from a desired user, the extraction processing unit F210 in this example extracts, as the load tendency of the desired user, the information (the presence or absence of a residual smell) registered in the residual smell field of the load tendency information table corresponding to the desired user. Also, the extraction processing unit F210 extracts, as the load histories of the rental vehicles 10 available for rent, the information (the presence or absence of a residual smell) registered in each of the residual smell fields of the load history information tables corresponding to the rental vehicles 10 available for rent.

The selection processing unit F220 in this example compares the presence or absence of a residual smell of the desired user with the presence or absence of a residual smell of each of the rental vehicles 10 available for rent thereby to select a renting vehicle from among the rental vehicles 10 available for rent. In this example, if the desired user has a load tendency with the presence of a residual smell, the selection processing unit F220 selects, as the renting vehicle, a rental vehicle 10 having a load history with the presence of a residual smell among the rental vehicles 10 available for rent. On the other hand, if the desired user has a load tendency with the presence of a residual smell, the selection processing unit F220 selects, as the renting vehicle, a rental vehicle 10 having a load history with the absence of a residual smell among the rental vehicles 10 available for rent.

When the renting vehicle is selected by the method described above, the vehicles rented to the users having a load tendency with the presence of a residual smell can be limited to specific rental vehicles 10 (rental vehicles 10 having a load history with the presence of a residual smell). In other words, it is possible to concentrate the load related to the indoor comfort on specific rental vehicles.

(Processing Flow)

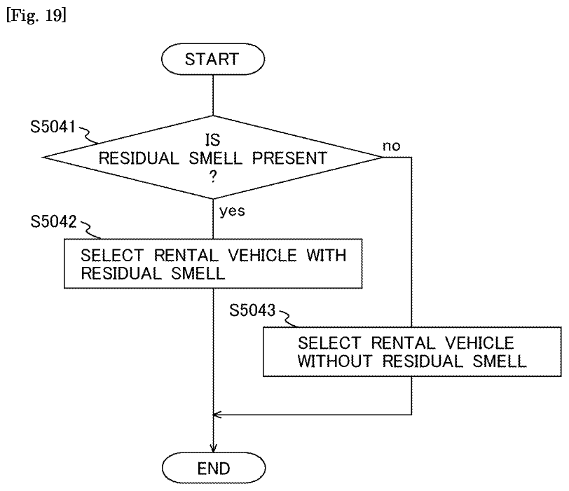

Next, a flow of processing to be performed by the server apparatus 200 in this example will be described. The server apparatus 200 of this example selects a renting vehicle in the same procedure as described in FIG. 6, when a rental request from a desired user is generated. However, in step S102, as the load tendency of the desired user, the presence or absence of a residual smell is extracted instead of the total travel distance. Also, in step S103, as the load histories of the rental vehicles 10 available for rent, the presence or absence of a residual smell is extracted instead of the cumulative travel distances. Then, in step S104, the processing flow of FIG. 19 is carried out instead of the above-mentioned flow of FIG. 7.

In the processing flow of FIG. 19, the selection processing unit F220 determines whether the desired user has a load tendency with the presence or absence of a residual smell (step S5041). When the desired user has a load tendency with the presence of a residual smell (an affirmative determination in step S5041), the selection processing unit F220 selects, as the renting vehicle, a rental vehicle 10 having a load history with the presence of a residual smell among the rental vehicles 10 available for rent (step S5042). On the other hand, when the desired user has a load tendency with the absence of a residual smell (a negative determination in step S5041), the selection processing unit F220 selects, as the renting vehicle, a rental vehicle 10 having a load history with the absence of a residual smell among the rental vehicles 10 available for rent (step S5043).

According to the processing flow of FIG. 19, in cases where a desired user has a load tendency with the presence of a residual smell, it will become to rent a rental vehicle 10 having a load history with the presence of a residual smell to the desired user. On the other hand, in cases where a desired user has a load tendency with the absence of a residual smell, it will become to rent a rental vehicle 10 having a load history with the absence of a residual smell to the desired user. With this, it becomes possible to limit the vehicles having a load history with the presence of a residual smell to specific rental vehicles 10. As a result, a rental vehicle 10 having a load history with the presence of a residual smell is suppressed from being rented out to a user having a load tendency with the absence of a residual smell. In other words, it is possible to ensure comfort at the time when a user having a load tendency with the absence of a residual smell makes use of a rental vehicle.

Here, note that in this embodiment, an example has been described in which a renting vehicle is selected based on the presence or absence of a residual smell, but a renting vehicle may be selected in consideration of the type of a residual smell in addition to the presence or absence of the residual smell. For example, for a user having a load tendency in which the residual smell of a cigarette is present, a rental vehicle 10 having a load history in which the residual smell of a cigarette is present may be rented out. Also, for a user having a load tendency in which the residual smell of a pet is present, a rental vehicle 10 having a load history in which the residual smell of a pet is present may be rented out. As a result, it is possible to suppress a rental vehicle 10 having a load history in which the residual smell of a cigarette is present from being rented out to a user who keeps a pet but does not smoke a cigarette. In addition, it is also possible to suppress a rental vehicle 10 having a load history in which the residual smell of a pet is present from being rented out to a user who smokes a cigarette and does not keep a pet.

<Others>

The above-mentioned embodiments are only some examples, and the present disclosure can be implemented while being changed or modified suitably without departing from the spirit and scope thereof. Further, at least two of the first through fifth embodiments described above may be implemented in combination with each other whenever possible.

In addition, the processings, units, devices and the like explained in this disclosure can be implemented in various combinations thereof, as long as technical inconsistency does not occur. Moreover, the processing(s) explained as carried out by a single device may be carried out by a plurality of devices. Alternatively, the processing(s) explained as carried out by different devices may be carried out by a single device. In a computer system, whether each function thereof is achieved by what kind of hardware configuration can be changed in a flexible manner.

Moreover, the present disclosure can also be achieved by supplying to a computer a computer program (i.e., information processing program) that implements the functions explained in the above-mentioned embodiments and modifications, and by reading out and executing the program by means of one or more processors of the computer. Such a computer program may be supplied to the computer by a non-transitory computer readable storage medium that can be connected to a system bus of the computer, or may be supplied to the computer through a network. The non-transitory computer readable storage medium is a recording medium that can store information such as data, programs, etc., by an electrical, magnetic, optical, mechanical, or chemical action, and can be read from the computer or the like. Such a non-transitory computer readable storage medium is, for example, any type of disk such as a magnetic disk (floppy disk, hard disk drive (HDD), etc.), an optical disk (CD-ROM, DVD disk, Blu-ray disk, etc.), or the like. In addition, the non-transitory computer readable storage medium may also be a medium such as a read-only memory (ROM), a random-access memory (RAM), an EPROM, an EEPROM, a magnetic card, a flash memory, an optical card, a solid-state drive (SSD), or the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An information processing apparatus for managing rental vehicles that are vehicles to be rented to users, the information processing apparatus comprising:
a first storage configured to store a load tendency in the form of information indicating a tendency of a load applied to a rental vehicle by each user when each user uses the rental vehicle, in association with each user;
a second storage configured to store a load history in the form of information indicating a history of a load received by each rental vehicle when each rental vehicle is rented out, in association with each rental vehicle; and
a controller configured to extract, upon generation of a rental request by a user who desires to rent a rental vehicle, a load tendency stored in the first storage in association with the desired user and a load history stored in the second storage in association with each of a plurality of rental vehicles that are available for rent, and to select a vehicle to be rented to the desired user from among the plurality of rental vehicles available for rent based on the load tendency and the load history thus extracted.

2. The information processing apparatus according to claim 1, wherein the load tendency includes at least one selected from the group comprising: a total travel distance that is a cumulative total of distance traveled by the rental vehicle when each user uses the rental vehicle; a continuous travel distance that is a continuous travel distance of the rental vehicle when each user uses the rental vehicle; a battery consumption amount that is a cumulative total of amount of battery consumption of the rental vehicle when each user uses the rental vehicle; a load weight that is a weight of a load loaded on the rental vehicle when each user uses the rental vehicle; and the presence or absence of a residual smell that is a smell remaining in an interior of the rental vehicle when each user returns the rental vehicle.

3. The information processing apparatus according to claim 2, wherein the controller selects, as the vehicle to be rented to the desired user, a rental vehicle having a load history in which in the case where the total travel distance, which is the load tendency of the desired user, is large, the cumulative travel distance is smaller, as compared with the case where the total travel distance is small.

4. The information processing apparatus according to claim 2, wherein the controller selects, as the vehicle to be rented to the desired user, a rental vehicle having a load history in which in the case where the continuous travel distance, which is the load tendency of the desired user, is large, the continuous travel distance is smaller, as compared with the case where the continuous travel distance is small.

5. The information processing apparatus according to claim 2, wherein the controller selects, as the vehicle to be rented to the desired user, a rental vehicle having a load history in which in the case where the battery consumption amount, which is the load tendency of the desired user, is large, a full charge amount of a battery is larger, as compared with the case where the battery consumption amount is small.

6. The information processing apparatus according to claim 2, wherein the controller selects, as the vehicle to be rented to the desired user, a rental vehicle having a load history in which in the case where the load weight, which is the load tendency of the desired user, is large, the load weight is smaller, as compared with the case where the load weight is small.

7. The information processing apparatus according to claim 2, wherein the controller selects, as the vehicle to be rented to the desired user, a rental vehicle having a load history in which the residual smell, which is the load tendency of the desired user, is present.

8. A non-transitory storage medium storing an information processing program for managing rental vehicles that are vehicles to be rented to users, the information processing program being configured to cause a computer to perform an extraction step and a selection step when a rental request is generated from a desired user who desires to rent a rental vehicle, wherein
the computer comprises: a first storage configured to store a load tendency in the form of information indicating a tendency of a load applied to a rental vehicle by each user when each user uses the rental vehicle, in association with each user; and a second storage configured to store a load history in the form of information indicating a history of a load received by each rental vehicle when each rental vehicle is rented out, in association with each rental vehicle;
the extraction step is configured to extract a load tendency stored in the first storage in association with the desired user and a load history stored in the second storage in association with each of a plurality of rental vehicles available for rent; and
the selection step is configured to select a vehicle to be rented to the desired user from among the plurality of rental vehicles available for rent based on the load tendency and the load history extracted in the extraction step.

9. The non-transitory storage medium according to claim 8, wherein the load tendency includes at least one selected from the group comprising: a total travel distance that is a cumulative total of distance traveled by the rental vehicle when each user uses the rental vehicle; a continuous travel distance that is a continuous travel distance of the rental vehicle when each user uses the rental vehicle; a battery consumption amount that is a cumulative total of amount of battery consumption of the rental vehicle when each user uses the rental vehicle; a load weight that is a weight of a load loaded on the rental vehicle when each user uses the rental vehicle; and the presence or absence of a residual smell that is a smell remaining in an interior of the rental vehicle when each user returns the rental vehicle.

10. The non-transitory storage medium according to claim 9, wherein in the selection step, there is selected, as the vehicle to be rented to the desired user, a rental vehicle having a load history in which in the case where the total travel distance, which is the load tendency of the desired user, is large, the cumulative travel distance is smaller, as compared with the case where the total travel distance is small.

11. The non-transitory storage medium according to claim 9, wherein in the selection step, there is selected, as the vehicle to be rented to the desired user, a rental vehicle having a load history in which in the case where the continuous travel distance, which is the load tendency of the desired user, is large, the continuous travel distance is smaller, as compared with the case where the continuous travel distance is small.

12. The non-transitory storage medium according to claim 9, wherein in the selection step, there is selected, as the vehicle to be rented to the desired user, a rental vehicle having a load history in which in the case where the battery consumption amount, which is the load tendency of the desired user, is large, a full charge amount of a battery is larger, as compared with the case where the battery consumption amount is small.

13. The non-transitory storage medium according to claim 9, wherein in the selection step, there is selected, as the vehicle to be rented to the desired user, a rental vehicle having a load history in which in the case where the load weight, which is the load tendency of the desired user, is large, the load weight is smaller, as compared with the case where the load weight is small.

14. The non-transitory storage medium according to claim 9, wherein in the selection step, there is selected, as the vehicle to be rented to the desired user, a rental vehicle having a load history in which the residual smell, which is the load tendency of the desired user, is present.

15. An information processing method for managing rental vehicles that are vehicles to be rented to users, the information processing method being configured to cause a computer to perform an extraction step and a selection step when a rental request is generated from a desired user who desires to rent a rental vehicle, wherein
the computer comprises: a first storage configured to store a load tendency in the form of information indicating a tendency of a load given to a rental vehicle by each user when each user has utilized the rental vehicle, in association with each user; and a second storage configured to store a load history in the form of information indicating a history of a load received by each rental vehicle when each rental vehicle has been rented out, in association with each rental vehicle;
the extraction step is configured to extract a load tendency stored in the first storage in association with the desired user and a load history stored in the second storage in association with each of a plurality of rental vehicles that are available for rent; and
the selection step is configured to select a vehicle to be rented to the desired user from among the plurality of rental vehicles available for rent based on the load tendency and the load history extracted in the extraction step.

16. The information processing method according to claim 15, wherein the load tendency includes at least one selected from the group comprising: a total travel distance that is a cumulative total of distance traveled by the rental vehicle when each user uses the rental vehicle; a continuous travel distance that is a continuous travel distance of the rental vehicle when each user uses the rental vehicle; a battery consumption amount that is a cumulative total of amount of battery consumption of the rental vehicle when each user uses the rental vehicle; a load weight that is a weight of a load loaded on the rental vehicle when each user uses the rental vehicle; and the presence or absence of a residual smell that is a smell remaining in an interior of the rental vehicle when each user returns the rental vehicle.

17. The information processing method according to claim 16, wherein in the selection step, there is selected, as the vehicle to be rented to the desired user, a rental vehicle having a load history in which in the case where the total travel distance, which is the load tendency of the desired user, is large, the cumulative travel distance is smaller, as compared with the case where the total travel distance is small.

18. The information processing method according to claim 16, wherein in the selection step, there is selected, as the vehicle to be rented to the desired user, a rental vehicle having a load history in which in the case where the continuous travel distance, which is the load tendency of the desired user, is large, the continuous travel distance is smaller, as compared with the case where the continuous travel distance is small.

19. The information processing method according to claim 16, wherein in the selection step, there is selected, as the vehicle to be rented to the desired user, a rental vehicle having a load history in which in the case where the battery consumption amount, which is the load tendency of the desired user, is large, a full charge amount of a battery is larger, as compared with the case where the battery consumption amount is small.

20. The information processing method according to claim 16, wherein in the selection step, there is selected, as the vehicle to be rented to the desired user, a rental vehicle having a load history in which in the case where the load weight, which is the load tendency of the desired user, is large, the load weight is smaller, as compared with the case where the load weight is small.
